(19) United States
(12) Patent Application Publication
(10) Pub. No.: US 2007/0174250 A1
(43) Pub. Date: Jul. 26, 2007

(54) Database mining for customer targeting

(75) Inventors: David Fox, San Francisco, CA (US); Kelli Fox, San Francisco, CA (US)

Correspondence Address: PERKINS COIE LLP, P.O. BOX 2168, MENLO PARK, CA, 94026, US

(73) Assignee: ZDK Interactive Inc., San Francisco, CA (US)

(21) Appl. No.: 11/487,145

(22) Filed: Jul. 13, 2006

Related U.S. Application Data
(63) Continuation-in-part of application No. 11/282,263, filed on Nov. 18, 2005.
(60) Provisional application No. 60/702,020, filed on Jul. 22, 2005.

(51) Int. Cl. G06F 17/30

(52) U.S. Cl. 707/3

(57) ABSTRACT

The present invention discloses a system and method for generating a subset of relevant entries. In one embodiment, a module comprises an input, a mapper, an extractor, a comparer, and an output. The input accepts a request from a user and the mapper maps the request to a predetermined formula corresponding to a range of birthdates. The extractor extracts birthdate information from each of a plurality of database entries and the comparer compares the extracted birthdate information to the range of birthdates. Entries within the range are flagged and the output generates a subset of relevant entries based on the flagged entries.

### PRIORITY CLAIM TO RELATED APPLICATION

The present application claims priority to Fox et al.'s Provisional Patent Application No. 60/702,020 for Computer Implemented Character Creation For An Interactive User Experience, filed on Jul. 22, 2005 and Fox et al.'s Utility patent application Ser. No. 11/281,263 for Computer Implemented Character Creation For An Interactive User Experience, filed on Nov. 15, 2005, both of which are incorporated herein by reference.

### BACKGROUND OF THE INVENTION

1. Field of Technology

The present invention generally relates to data mining. Specifically, the present invention relates to the use birthdates in conjunction with predetermined formulas to generate a subset of relevant entries from a database.

2. Description of Related Art

Data mining is a term used in the art to describe the extraction of potentially useful information from data. Data mining is normally used in conjunction with databases to determine correlations among data entries. As such, data mining is normally used to identify trends or habits of the subjects within the database.

An example of data mining involves a database of potential customers for a particular business. The business can track and record purchases made by a customer over a period of time. Once sufficient time has passed, a correlation can be made between the customer and the purchases made by the customer. Marketing materials, promotional items, associated products and the like can be generated and presented to the customers based on the correlation. The customer, thereby, purchases more items in accordance with the customer's spending habits.

However, spending is not based solely on previous purchases. Spending is also based on a variety of emotional factors. Feeling of happiness, sadness, love, boredom, greed, grief, selfishness, amusement, anger, fear, comfort, envy, jealously, gratitude, hope, kindness, among others greatly affect when, how, what or why a person will purchase a product. Previous data mining techniques are unable to foresee the psyche of the customer to predict spending habits based on these emotional factors.

What is needed is a system and method for determining a subset of relevant database entries using criteria to foresee the spending habits of the customer. Further, what is needed, is a system for predicting the reaction of a customer based on the features of a document, such as a marketing brochure.

### SUMMARY OF THE INVENTION

In one embodiment, a module for generating a subset of relevant database entries is disclosed. The module comprises an input, a mapper, an extractor, a comparer, and an output. The input can accept requests from a user. The mapper can map the requests to at least one of a plurality of predetermined formulas. Each of the predetermined formulas can correspond to a range of birthdates. The extractor can extract birthdate information from each of a plurality of database entries. The comparer can compare the extracted birthdate information to the range of birthdates and flag the entries which are in range. The output can generate a subset of relevant entries, based on the flagged entries, and provide the subset to the user.

In additional embodiments, the input can be facilitated using a GUI. Further, in other embodiments, at least some of the predetermined formulas can be based on natal and/or transit charts which can be used to foresee the psyche of the customer. In certain embodiments, the subset of relevant entries can be used to generate a distribution list and/or custom advertising. The requests can also be instructions to generate a list of people in a buying, investigative, and/or research mode, and the subset of relevant entries can be the desired list.

Another embodiment discloses a database from which a distribution list is generated. The database comprises a plurality of entries. Each of the entries can comprise a name, an address, buying history, and a birthdate of a person. The distribution list can be generated by using the birthdates to determine the emotional state of the people in the database. In other embodiments, the distribution list can be generated and sold for marketing purposes and/or to vendors. Further, marketing materials can be generated based, at least in part, on the distribution list and sent to potential customers. Customers can be notified of the criteria used to send the marketing materials in order to dispense of the notion that the advertising is random.

A system for generating a subset of relevant entries from a database is disclosed in an additional embodiment. The system comprises a database and a module. The database can have a plurality of entries that reference a plurality of people. Each of the entries can comprise a reference to a person and the person's birthdate. The module can analyze the plurality of entries in the database and generate a subset of relevant entries. The module can use the birthdate as one criteria to generate the subset of relevant entries.

In further embodiments, the module can comprise an input, a mapper, an extractor, a comparer and an output. The input can accept requests from a user. The mapper can map the request to at least one of a plurality of predetermined formulas. Each of the formulas can correspond to a range of birthdates. The extractor can extract the birthdate from each of the entries and the comparer can compare the birthdate to the range of birthdates. If the birthdate is within the range, the entry can be flagged and included in the output as part of the relevant subset of entries.

In alternate embodiments, the reference to the person can be the person's name. Moreover, the plurality of entries can further comprise an address of the person. The request can be an instruction to generate a list of people in a buying, investigative, and/or research mode, and the subset of relevant entries can be the desired list. Each of the entries can further comprise a birthtime which can be used by the module to generate the subset of relevant entries. The subset of relevant entries can be used to compile a mass mailing to customers who are in the appropriate mode.

Another embodiment of the present invention is a reaction prediction tool. The reaction prediction tool comprises an input, a mapper, an extractor, a comparer, and an output. The input can receive features of an existing document from a user. The mapper can map the features to a range of birthdates using at least one of a plurality of predetermined formulas. The extractor can extract a birthdate from each of a plurality of database entries which reference a plurality of people. The comparer can compare each of the birthdates to the range of birthdates and flag the entries with birthdates within range. The output can generate a subset of the plurality of people, based upon the flagged entries, who will react to the features in a desired manner.

In alternate embodiments, at least some of the predetermine formulas can be based on natal and/or transit charts and be used to foresee the psyche of the customers. For example, the predetermined formulas can correspond to people in a buying, investigative and/or research mode. The subset of the plurality of people can be those who react favorably to the document features and used to generate a distribution list and/or additional marketing material.

A method for generating a subset of relevant database entries is also disclosed. The method includes receiving a request from a user. Once received, the request is mapped to at least one of a plurality of predetermine formulas. Each of the predetermined formulas can correspond to a range of birthdates. Birthdate information is extracted from each of a plurality of database entries. The birthdate information is compared to the range of birthdates. The entries containing birthdates within the range of birthdates are flagged. A subset of relevant entries is generated based on the flagged entries. Once generated, the subset is provided to the user.

In alternate embodiments, at least some of the predetermined formulas are based on natal and/or transit charts to predict the emotional state of the customer. For example, the request can be an instruction to generate a list of people in a buying, investigative, and/or research mode, and the subset of relevant entries can be the list of people in the appropriate mode. The subset of relevant entries can be used to generate a distribution list and/or used to generate custom advertising. In additional embodiments, the birthdate information can include both birthdate and birth time.

In certain embodiments, a method for generating a subset of relevant entries from a database is disclosed. The method comprises receiving a request to generate a subset of relevant entries from a database. The database can have a plurality of entries referencing a plurality of people. Each of the entries can comprise a reference to one of a plurality of people and a birthdate of the person referenced. The subset of relevant entries can be generated using a formula which is based, at least in part, on the birthdate. In alternate embodiments, the request can be an instruction to provide a subset of customers who are in a buying, investigative, and/or research mode in order to generate relevant material and/or products.

As described above, and in alternate embodiments that would be apparent to one skilled in the art, generating a subset of relevant database entries using birthdate information facilitates the use of additional criteria, including emotional factors and modes, to create appropriate material for existing and/or potential customers.

### BRIEF DESCRIPTION OF THE DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 illustrates a module for generating a subset of relevant database entries.

FIG. 2 illustrates a database from which a distribution list is generated.

FIG. 3 illustrates a system for generating a subset of relevant entries from a database.

FIG. 4 illustrates a reaction prediction tool.

FIG. 5 illustrates a method of generating a subset of relevant database entries.

FIG. 6 illustrates a method of generating a subset of relevant entries.

### DETAILED DESCRIPTION OF DRAWINGS

The present invention teaches a variety of devices, methods, and other subject matter described herein or apparent to one skilled in the art in light of the present teaching. The present invention further teaches a variety of embodiments, aspects and the like, all distinctive in their own right. The person of skill in the art suitable for the present invention can have a background from computer science, computer engineering, electrical engineering, or the like.

The systems and methods taught by the present invention generate a subset of relevant entries from a database. The generation of the subset is facilitated utilizing birthdate information in order to identify the emotional mode of existing and/or potential customers. The resulting subset of entries can be used to generate promotional, marketing, advertising or similar materials which can be distributed to consumers.

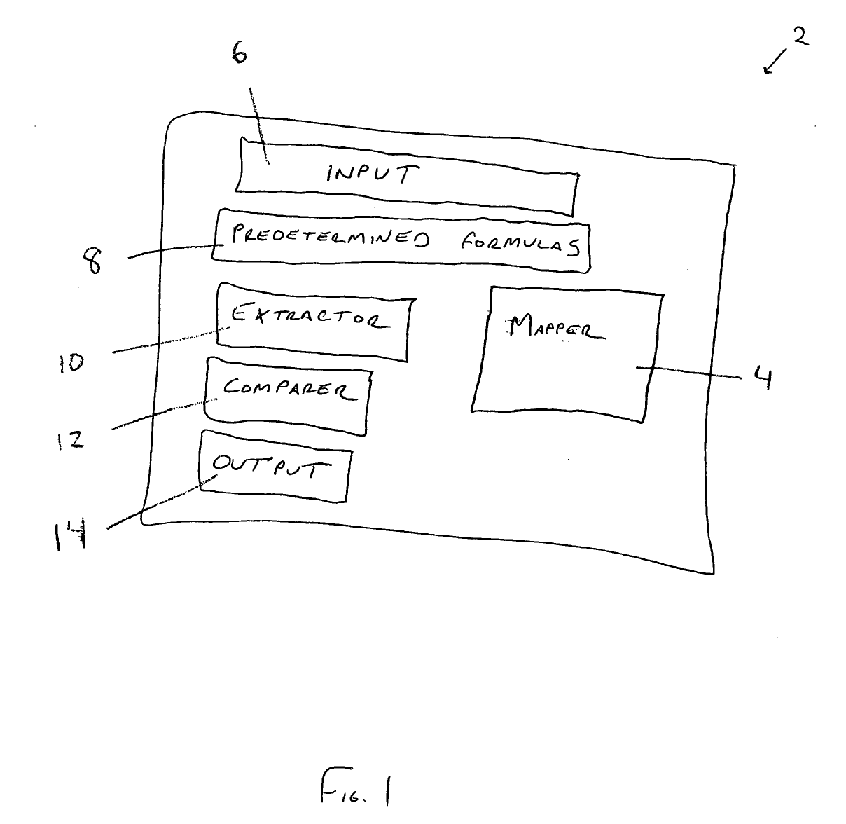

FIG. 1 illustrates a module 2 for generating a subset of relevant database entries. In the embodiment illustrated, the module includes an input 6, a mapper 4, a plurality of predetermined formulas 8, an extractor 10, a comparer 12, and an output 14. The input 6 is capable of receiving a request from a user. The request can be provided to the input in any convenient and/or known manner, external or internal, including external peripheral devices, internal bus, and/or network connection. The request can facilitated in any convenient and/or known manner including a mouse click, text, keyboard entry, speech, touch, data transfer, wireless communication, frequency modulation, electrical signal, or any other manual or automatic process capable producing a command. Further, the user can be anything capable of communication including humans and machines. The mapper 4 maps the request to at least one of the predetermined formulas 8. The extractor 10 extracts birthdate information from a plurality of database entries. The extraction can be facilitated using artificial intelligence, data processing techniques, search engines, statistical algorithms and/or any other process that facilitates the extraction of data. The comparer 12 compares the extracted birthdate information to the range of birthdates generated by the formulas. The entries that contain birthdates within the range are flagged. Entries can be flagged by inclusion into a subset and/or using an indicium. The output generates a subset of relevant entries, which are based on the flagged entries, and provides the subset to the user.

By way of working, non-limiting example, a user can provide an instruction to generate a list of customers who are in an emotionally buying mode. The mapper 4 can map the instruction to formulas 8 that are based on natal and transit charts. By applying the natal and transit chart formulas 8, a range of birthdate and birthtimes for people who are currently in a buying mode is determined. Birthdate and birthtime information is then extracted from a database (by the extractor 10) and compared to the range (by the comparer 12). The output 14 is a list of all people having birthdates and birthtimes within the range, and therefore is a list of customers in a buying mode. Using the list, marketing materials can be created and distributed to the appropriate customers.

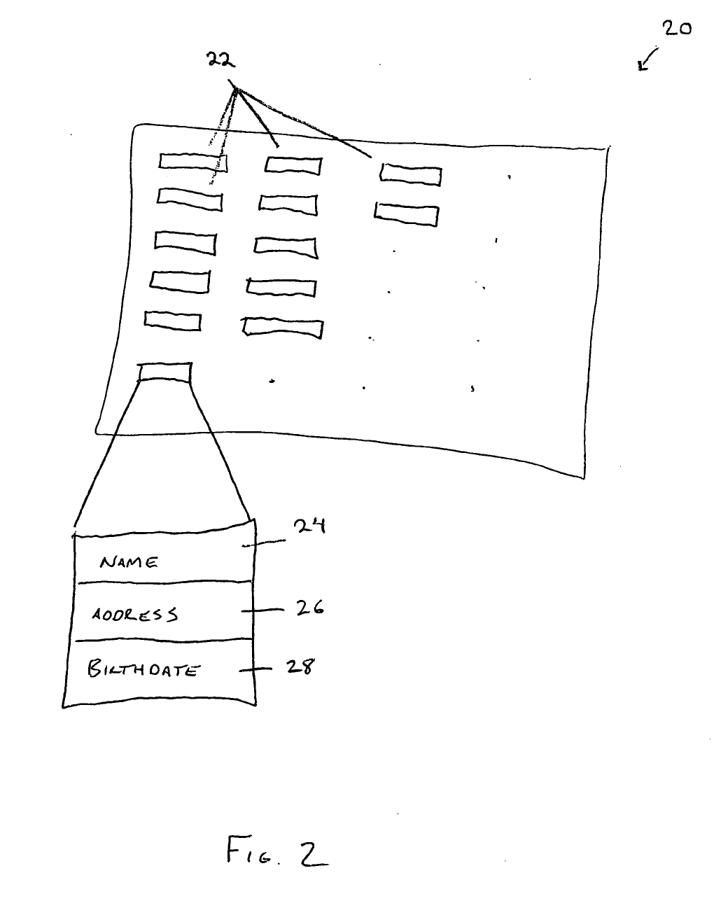

FIG. 2 illustrates a database 20 from which a distribution list is generated. In the embodiment illustrated, the database 20 includes a plurality of entries 22. Each of the entries includes a name 24 of a person, an address 26 of the person, and a birthdate 28 of the person. A formula utilizing the birthdates generates the desired distribution list from the database 20. As illustrated, the module in FIG. 1 can be used to generate a subset of relevant entries from the database illustrated in FIG. 2.

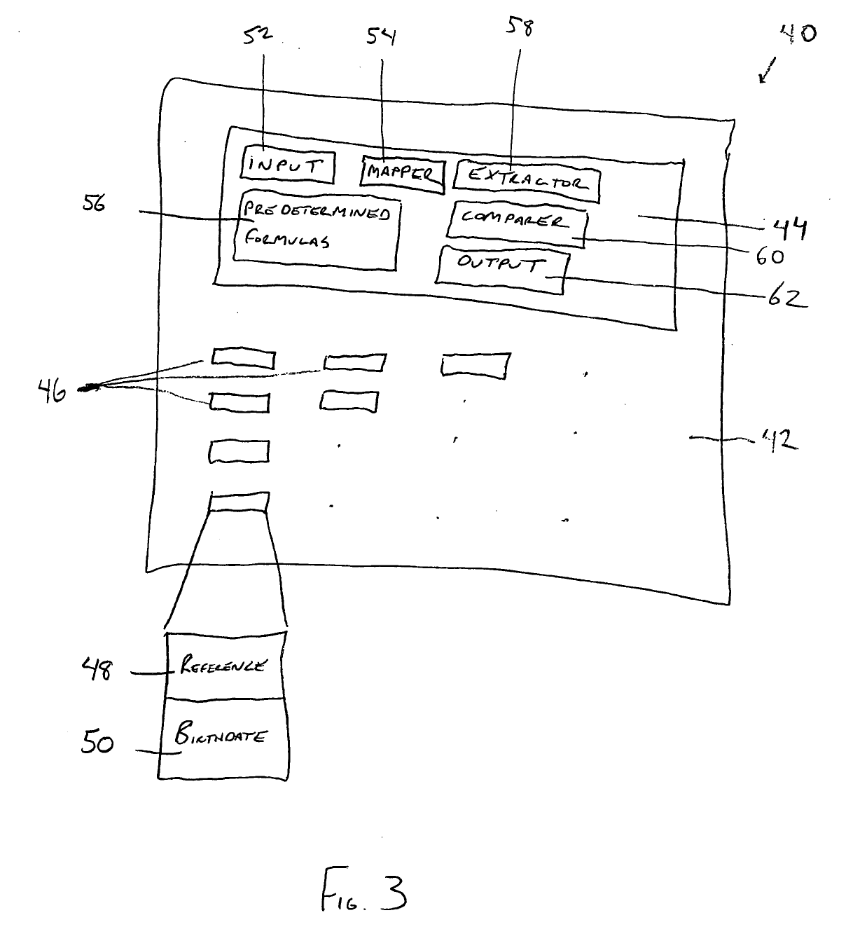

FIG. 3 illustrates a system 40 for generating a subset of relevant entries from a database. The system 40 includes a database 42 and a module 44. The database 40 includes a plurality of entries 46. Each entry includes a reference 48 to a person and a birthdate of the person 50. The module 44 includes an input 52, a mapper 54, a plurality of predetermined formulas 56, an extractor 58, a comparer 60, and an output 62. The input 52 is capable of receiving a request from a user. The request can be provided to the input in any convenient and/or known manner, external or internal, including external peripheral devices, internal bus, and/or network connection. The request can facilitated in any convenient and/or known manner including a mouse click, text, keyboard entry, speech, touch, data transfer, wireless communication, frequency modulation, electrical signal, or any other manual or automatic process capable producing a command. Further, the user can be anything capable of communication including humans and machines. The mapper 54 maps the request to at least one of the predetermined formulas 56. The extractor 58 extracts birthdate information from the plurality of database entries 46. The extraction can be facilitated using artificial intelligence, data processing techniques, search engines, statistical algorithms and/or any other processes that facilitate the extraction of data. The comparer 60 compares the extracted birthdate information to the range of birthdates generated by the formulas. The entries that contain birthdates within the range are flagged. Entries can be flagged by inclusion into a subset and/or using an indicium. The output 62 generates a subset of relevant entries, which are based on the flagged entries, and provides the subset to the user.

By way of working, non-limiting example, a user can provide an instruction to generate a list of customers who will be in an emotionally investigative mode in the next six months. The mapper 54 can map the instruction to formulas 56 that are based on composite charts (a composite chart is a merging of two or more natal charts). By applying the composite chart formula 8, a range of birthdates for people who will be in an investigative mode in the next six months is determined. The birthdate information is then extracted from the database 42 and compared to the range using the extractor 58 and comparer 60. The output 62 is a list of all people having birthdates within the range, and therefore are people who will be in an investigative mode in the next six months. Using the list, promotional materials can be generated and distributed to the appropriate people.

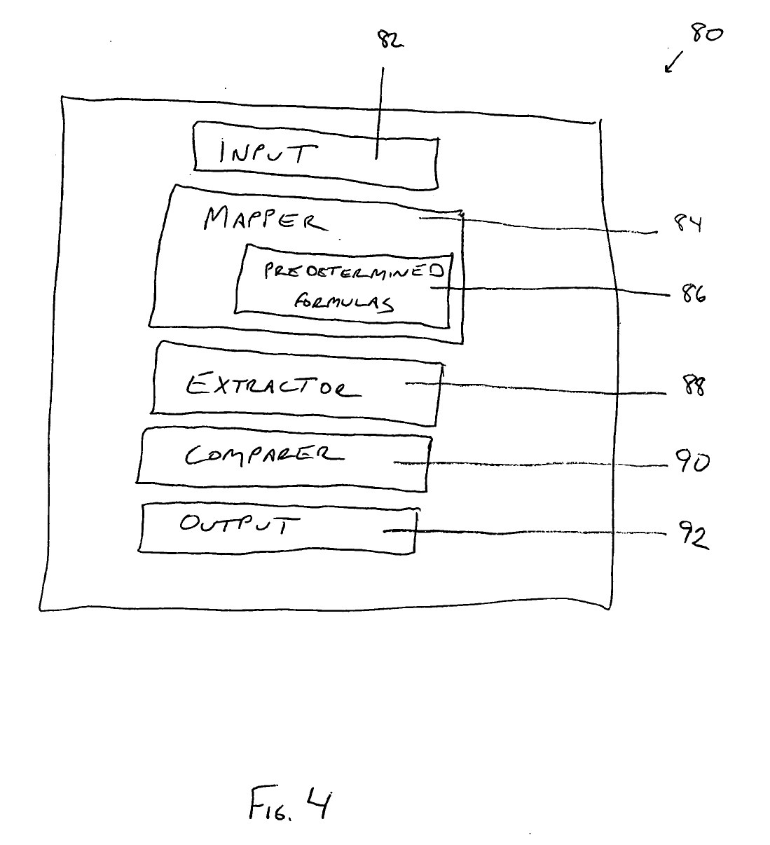

FIG. 4 illustrates a reaction prediction tool 80. In the embodiment illustrated, the reaction prediction tool 80 includes an input 82, a mapper 84, a plurality of predetermined formulas 86, an extractor 88, a comparer 90, and an output 92. The input 82 receives features of an existing document from a user. The mapper 84 maps the features to a range of birthdates using the predetermined formulas 86. The extractor 88 extracts birthdate information from a plurality of database entries. The comparer 90 compares the extracted birthdate information to the range of birthdates generated by the formulas 86. The entries that contain birthdates within the range are flagged. The output 92, which is based on the flagged entries, generates a subset of people who will react to the features in a desired manner.

By way of working, non-limiting example, the input 82 can receive features of a marketing brochure from a user. The user can be a human who manually input the features of the marketing brochure, such as color, shape, font, graphics, tone, product, word choice, and/or any other descriptive features. Alternatively, the user can be a machine that provides a scan of the marketing brochure to the input. Once the features have been identified, the mapper 84 can map the features to a range of birthdates using predetermined formulas 86. The formulas 86 can be based on natal charts and be used to determine who will be most influenced by the marketing brochure's features. For example, if the marketing brochure is blue, applying the formulas would yield a range of birthdates that would be most influenced by the color blue at the time the brochure is sent. The birthdate information is then extracted from the database and compared to the range using the extractor 88 and comparer 90. The output 92 is a generated list of all people having birthdates within the range. Thus, the output 92 is a list of all people who would be most influenced by the features of the marketing brochure at the time the marketing brochure is sent.

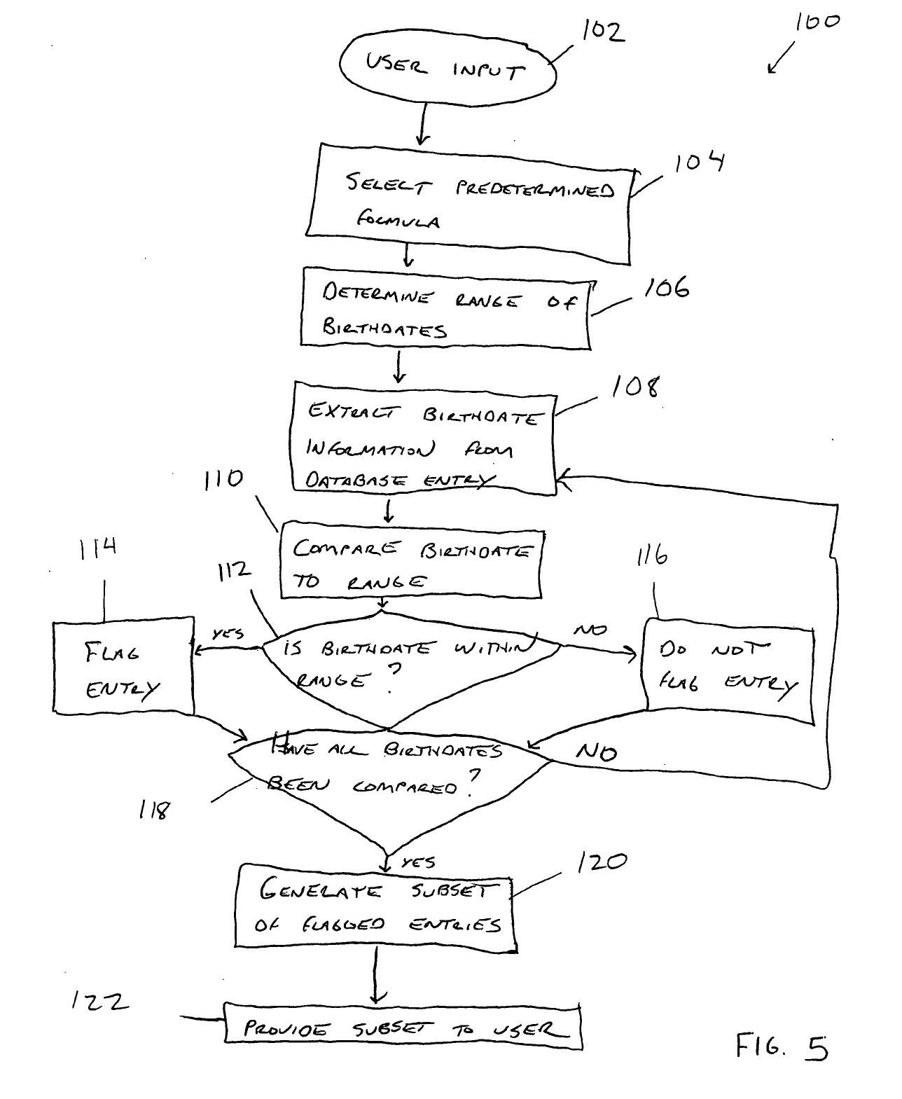

FIG. 5 illustrates a method 100 of generating a subset of relevant database entries. In the embodiment illustrated, a step 102 receives user input. The receiving of user input 102 can be facilitated using text, hyperlinks, windows, menus, radio buttons, check boxes, icons, CLI, PUI, GUI, or any other device capable of interacting with and/or obtaining data from a user. Further, a user can be any entity that provides information to the system, including a human and/or machine. A step 104 selects at least one of a plurality of formulas. Using the selected predetermined formulas, a step 106 determines an appropriate range of birthdates. Once the range of birthdates has been determined, a step 108 extracts birthdate information from at least one entry in a database. The extracted birthdate is compared to the range of birthdates in a step 110. Step 112 determines whether the extracted birthdate is within range. If so, a step 114 flags the entry. If not, a step 116 does not flag the entry. In either case, a step 118 determines whether all of the birthdates have been extracted and compared to the range of birthdates. If not, steps 108-118 are repeated until birthdates in the database of entries has been compared to the range of birthdates. Once all birthdates have been compared, a subset of flagged entries is generated in step 120. A step 122 provides the subset of flagged or relevant entries to the user.

In alternate embodiments, the steps and/or sequence of steps can be modified. For example, birthdate information can be extracted from the entries in the database before the range of birthdates is determined, the predetermined formula is selected, or the input is received. Further, in other embodiments, all of the birthdate information can be extracted from all of the entries in the database and then compared to the range of birthdates. In another embodiment, the user can select the predetermined formula or can create a formula to be used to determine the range of birthdates. In certain embodiments, the predetermined formulas can be based on natal, transit, or composite charts. Moreover, in additional embodiments, the flagging of entries can be facilitated by inclusion into a subset of entries and/or manipulating the entry using an indicium. The subset can be provided to the user in any convenient and/or known manner capable of communicating information to a user.

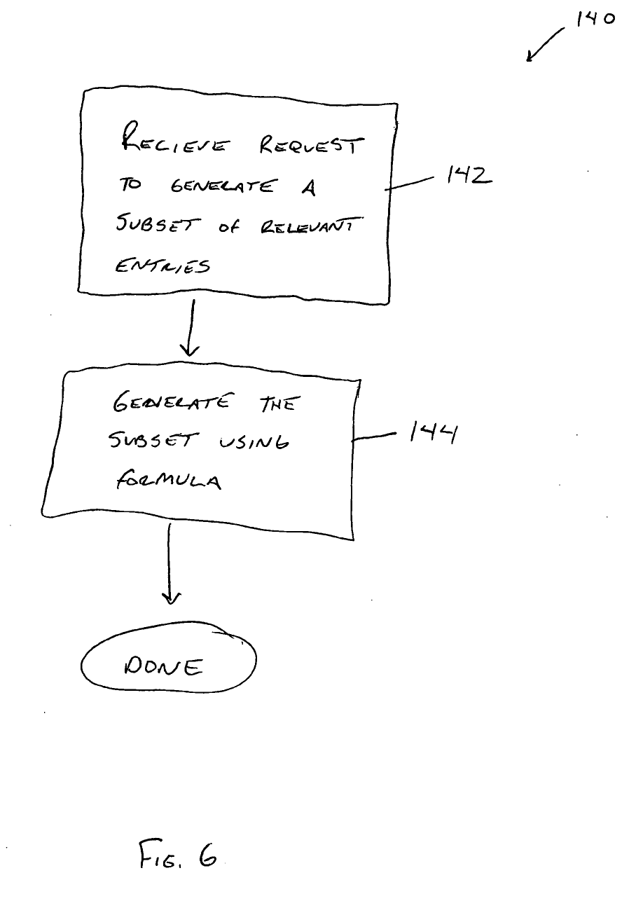

FIG. 6 illustrates a method of 140 of generating a subset of relevant entries. In the embodiment illustrated, a step 142 receives a request to generate a subset of relevant entries from a database. The database can have a plurality of entries referencing a plurality of people. Each of the entries can comprise a reference to a person and a birthdate of the person. In a step 144, a subset of relevant entries is generated using a formula. The formula can be based on the birthdate of the person a capable of predicting emotional state.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

1. A module for generating a subset of relevant database entries, comprising:
an input capable of receiving a request from a user,
a mapper capable of mapping said request to at least one of a plurality of predetermined formulas, each of said predetermined formulas corresponding to a range of birthdates,
an extractor capable of extracting birthdate information from each of a plurality of database entries,
a comparer capable of comparing said birthdate information to said range of birthdates and flagging said entries in which said birthdate information is within said range of birthdates, and
an output capable of generating a subset of relevant entries and providing said subset of relevant entries to said user, said subset of relevant entries being based upon said flagged entries.

2. A module for generating a subset of relevant database entries as recited in claim 1, wherein said input is facilitated using a graphical user interface (GUI).

3. A module for generating a subset of relevant database entries as recited in claim 1, wherein said birthdate information includes birthdate and birthtime.

4. A module for generating a subset of relevant database entries as recited in claim 1, wherein at least one of said predetermined formulas are based on natal charts.

5. A module for generating a subset of relevant database entries as recited in claim 1, wherein at least some of said predetermined formulas are based on transit charts.

6. A module for generating a subset of relevant database entries as recited in claim 1, wherein said subset of relevant entries is used to generate a distribution list of potential customers.

7. A module for generating a subset of relevant database entries as recited in claim 1, wherein said subset of relevant entries is used to foresee a psyche of a customer.

8. A module for generating a subset of relevant database entries as recited in claim 1, wherein said request is an instruction to generate a list of people in a buying mode and said subset of relevant entries is said list of people.

9. A module for generating a subset of relevant database entries as recited in claim 1, wherein said request is an instruction to generate a list of people in an investigative mode and said subset of relevant entries is said list of people.

10. A module for generating a subset of relevant database entries as recited in claim 1, wherein said request is an instruction to generate a list of people in a research mode and said subset of relevant entries is said list of people.

11. A module for generating a subset of relevant database entries as recited in claim 1, wherein said request is an instruction to provide a subset of people in a particular emotional state at a particular point in the future.

12. A module for generating a subset of relevant database entries as recited in claim 1, wherein said subset of relevant entries is used to generate custom advertising.

13. A module for generating a subset of relevant database entries as recited in claim 1, wherein said subset of relevant entries is used to generate marketing materials.

14. A database from which a distribution list is generated, comprising:
a plurality of entries, each of said entries referencing a person, each of said entries comprising:
a name of said person,
an address of said person,
buying history of said person, and
a birthdate of said person;
wherein said birthdates are used, at least in part, as part of a formula to determine an emotional state of said person and to generate a distribution list comprising people having a desired emotional state.

15. A database from which a distribution list is generated as recited in claim 14, wherein said distribution list is generated and sold for marketing purposes.

16. A database from which a distribution list is generated as recited in claim 14, wherein said distribution list is sold to vendors.

17. A database from which a distribution list is generated as recited in claim 14, wherein marketing materials are prepared based, at least in part, on said distribution list.

18. A database from which a distribution list is generated as recited in claim 17, wherein marketed persons are notified of selection criteria.

19. A system for generating a subset of relevant entries from a database comprising:
a database having a plurality of entries referencing a plurality of people, each of said entries comprising:
a reference to one of said plurality of people, and
a birthdate of said one of said plurality of people; and
a module capable of analyzing said plurality of entries in said database and generating a subset of relevant entries, said module using said birthdates as one criteria to generate said subset of relevant entries.

20. A system for generating a subset of relevant entries from a database as recited in claim 19, wherein said module comprises:
an input capable of receiving a request from a user,
a mapper capable of mapping said request to at least one of a plurality of predetermined formulas, each of said predetermined formulas corresponding to a range of birthdates,
an extractor capable of extracting said birthdate from each of said plurality of entries,
a comparer capable of comparing said birthdate to said range of birthdates and flagging said entries in which said birthdate is within said range of birthdates, and
an output capable of generating said subset of relevant entries and providing said subset of relevant entries to said user, said subset of relevant entries being based upon said flagged entries.

21. A system for generating a subset of relevant entries from a database as recited in claim 19, wherein said reference to one of said plurality of people is a name.

22. A system for generating a subset of relevant entries from a database as recited in claim 19, wherein each of said plurality of entries further comprises an address of said one of said plurality of people.

23. A system for generating a subset of relevant entries from a database as recited in claim 20, wherein said request is an instruction to generate a list of people in a buying mode.

24. A system for generating a subset of relevant entries from a database as recited in claim 23, wherein said subset of relevant entries is said list of people in said buying mode.

25. A system for generating a subset of relevant entries from a database as recited in claim 20, wherein said request is an instruction to generate a list of people in an investigative mode.

26. A system for generating a subset of relevant entries from a database as recited in claim 25, wherein said subset of relevant entries is said list of people in said investigative mode.

27. A system for generating a subset of relevant entries from a database as recited in claim 20, wherein said request is an instruction to generate a list of people in a research mode.

28. A system for generating a subset of relevant entries from a database as recited in claim 27, wherein said subset of relevant entries is said list of people in said research mode.

29. A system for generating a subset of relevant entries from a database as recited in claim 20, wherein said request is an instruction to provide a subset of people in a particular emotional state at a particular point in the future.

30. A system for generating a subset of relevant entries from a database as recited in claim 19, wherein each of said entries further comprises a birthtime, and said module uses said birthtime to generate said subset of relevant entries.

31. A system for generating a subset of relevant entries from a database as recited in claim 19, wherein said subset of relevant entries is used to compile a mass mailing.

32. A reaction prediction tool comprising:
an input capable of receiving features of an existing document from a user,
a mapper capable of mapping said features to a range of birthdates using at least one of a plurality of predetermined formulas,
an extractor capable of extracting a birthdate from each of a plurality of database entries, said database entries referencing a plurality of people,
a comparer capable of comparing each of said birthdates to said range of birthdates and flagging said entries in which said birthdate is within said range of birthdates, and
an output capable of generating a subset of said plurality of people who will react to said features in a desired manner, said subset based upon said flagged entries.

33. A reaction based generation tool as recited in claim 32, wherein at least some of said predetermined formulas are based on natal charts.

34. A reaction based generation tool as recited in claim 32, wherein at least some of said predetermined formulas are based on transit charts.

35. A reaction based generation tool as recited in claim 32, wherein said subset of said plurality of people are members of a distribution list.

36. A reaction based generation tool as recited in claim 32, wherein said predetermined formula corresponds to people in a buying mode and said subset of said plurality of people react favorably to said document features.

37. A reaction based generation tool as recited in claim 32, wherein said predetermined formula corresponds to people in an investigative mode and said subset of said plurality of people react favorably to said document features.

38. A reaction based generation tool as recited in claim 32, wherein said predetermined formula corresponds to people in a research mode and said subset of said plurality of people react favorably to said document features.

39. A method for generating a subset of relevant database entries, comprising:
receiving a request from a user,
mapping said request to at least one of a plurality of predetermined formulas, each of said predetermined formulas corresponding to a range of birthdates,
extracting birthdate information from each of a plurality of database entries,
comparing said birthdate information to said range of birthdates,
flagging said entries in which said birthdate information is within said range of birthdates,
generating a subset of relevant entries, said subset of relevant entries being based upon said flagged entries, and
providing said subset of relevant entries to said user.

40. A method for generating a subset of relevant database entries as recited in claim 39, wherein at least some of said predetermined formulas are based on natal charts.

41. A method for generating a subset of relevant database entries as recited in claim 39, wherein at least some of said predetermined formulas are based on transit charts.

42. A method for generating a subset of relevant database entries as recited in claim 39, further comprising generating a distribution list based upon said subset of relevant entries.

43. A method for generating a subset of relevant database entries as recited in claim 39, further comprising generating marketing material based upon said subset of relevant entries.

44. A method for generating a subset of relevant database entries as recited in claim 39, wherein said request is an instruction to generate a list of people in a buying mode and said subset of relevant entries is said list of people.

45. A method for generating a subset of relevant database entries as recited in claim 39, wherein said request is an instruction to generate a list of people in an investigative mode and said subset of relevant entries is said list of people.

46. A method for generating a subset of relevant database entries as recited in claim 39, wherein said request is an instruction to generate a list of people in a research mode and said subset of relevant entries is said list of people.

47. A method for generating a subset of relevant database entries as recited in claim 39, wherein said request is an instruction to provide a subset of people in a particular emotional state at a particular point in the future.

48. A method for generating a subset of relevant database entries as recited in claim 39, further comprising generating advertising based upon said subset of relevant entries.

49. A method for generating a subset of relevant database entries as recited in claim 39, wherein birthdate information includes birthdate and birth time.

50. A method for generating a subset of relevant entries from a database comprising:
receiving a request to generate a subset of relevant entries from a database, said database having a plurality of entries referencing a plurality of people, each of said plurality of entries comprising a reference to one of said plurality of people and a birthdate of said one of said plurality of people,
generating said subset of relevant entries using a formula, said formula based at least in part on said birthdate and capable of predicting emotional state.

51. A method for generating a subset of relevant entries from a database as recited in claim 50, wherein said request is an instruction to provide a subset of customers who are in a buying mode.

52. A method for generating a subset of relevant entries from a database as recited in claim 50, wherein said request is an instruction to provide a subset of customers who are in an investigative mode.

53. A method for generating a subset of relevant entries from a database as recited in claim 50, wherein said request is an instruction to provide a subset of customers who are in a research mode.

54. A method for generating a subset of relevant entries from a database as recited in claim 50, wherein said request is an instruction to provide a subset of customers in a particular emotional state at a particular point in the future.
